(19) United States
(12) Patent Application Publication
(10) Pub. No.: US 2025/0286050 A1
(43) Pub. Date: Sep. 11, 2025

(54) NEGATIVE ELECTRODE MATERIAL, NEGATIVE ELECTRODE PLATE, AND BATTERY

(71) Applicant: ZHUHAI COSMX BATTERY CO., LTD., Zhuhai (CN)

(72) Inventors: Hui WANG, Zhuhai (CN); Jiachen XUE, Zhuhai (CN); Chunyang LIU, Zhuhai (CN); Suli LI, Zhuhai (CN)

(73) Assignee: ZHUHAI COSMX BATTERY CO., LTD., Zhuhai (CN)

(21) Appl. No.: 19/217,144

(22) Filed: May 23, 2025

Related U.S. Application Data
(63) Continuation of application No. PCT/CN2024/074308, filed on Jan. 26, 2024.

(30) Foreign Application Priority Data
Mar. 4, 2023 (CN) 202310199622.0

(51) Int. Cl. H01M 4/36; H01M 4/02; H01M 4/133; H01M 4/38; H01M 4/587; H01M 4/62; H01M 10/0525

(52) U.S. Cl. CPC H01M 4/366; H01M 4/133; H01M 4/364; H01M 4/386; H01M 4/587; H01M 4/625; H01M 10/0525; H01M 2004/021; H01M 2004/027

(57) ABSTRACT

Disclosed are a negative electrode material, a negative electrode plate and a battery. The negative electrode material has a core-shell structure, a shell layer includes a carbon layer, a core includes porous carbon and silicon particles distributed in an outer pore of the porous carbon, the porous carbon further includes an inner pore, and the negative electrode material includes a metal element. The negative electrode material in the present disclosure can provide buffer space when lithium intercalation volume expansion occurs on silicon particles, and has high stability on an interface with an electrolyte solution interface. The negative electrode plate including the negative electrode material of the present disclosure has features of high specific capacity and high initial Coulombic efficiency. The battery including the negative electrode plate in the present disclosure has high energy density, high cycling stability, good rate performance, and a low volume expansion rate.

### CROSS-REFERENCE TO RELATED APPLICATIONS

The present disclosure is a continuation of International Application No. PCT/CN2024/074308, filed on Jan. 26, 2024, which claims priority to Chinese Patent Application No. 202310199622.0, filed on Mar. 4, 2023. All of the aforementioned applications are incorporated herein by reference in their entireties.

### TECHNICAL FIELD

The present disclosure relates to the field of battery technologies, and specifically, to a negative electrode material, and a negative electrode plate and a battery including the negative electrode material.

### BACKGROUND

Lithium-ion secondary batteries are widely used in various fields such as mobile electronic devices, electric vehicles, and energy storage power stations due to their advantages such as high energy density, long cycle life, and high safety. With the development of recent years, performance of the graphite negative electrode used in a conventional lithium-ion battery has been gradually developed to approach its theoretical limit, which restricts further improvement of energy density of the lithium-ion battery. A silicon-based material has a theoretical lithium storage capacity that is nearly 10 times that of graphite material, and silicon is abundant in the earth's crust, making it one of the ideal negative electrode materials for a next generation of lithium-ion batteries with a high energy density. However, after lithium intercalation, silicon undergoes volume expansion of over 300%, which may easily cause problems such as particle pulverization, electrode structure damage, and repeated rupture and growth of a passivation layer on a negative electrode surface. This results in negative impacts such as rapid degradation of battery cycle life and an excessively high volume expansion rate of a battery. In addition, silicon is a semiconductor, and electronic conductivity of the silicon also restricts rate performance of a lithium-ion battery.

To resolve the foregoing problems of a silicon-based material, the industry has proposed improving cycling performance of the silicon negative electrode by constructing a carbon coating layer on a surface of silicon particles to buffer volume expansion during lithium intercalation of the silicon particles. However, the carbon coating layer in the silicon carbon material with this structure will undergo a corresponding deformation when volume expansion occurs on a silicon core during lithium intercalation. When a silicon content is relatively high (>30%), the deformation easily causes rupture and failure of the carbon coating layer, resulting in rapid deterioration of performance of the lithium-ion battery.

Therefore, it is very important to invent a battery with a high energy density, high cycling stability, good rate performance, and a low volume expansion rate.

### SUMMARY

The objective of the present disclosure is to overcome the foregoing problems in a conventional technology by providing a negative electrode material, and a negative electrode plate and a battery including the negative electrode material. The negative electrode material in the present disclosure has high conductivity, can provide buffer space when lithium intercalation volume expansion occurs on silicon particles, and has high stability on an interface with an electrolyte solution. The negative electrode plate including the negative electrode material of the present disclosure has features of high specific capacity and high initial Coulombic efficiency. The battery including the negative electrode plate in the present disclosure has high energy density, high cycling stability, good rate performance, and a low volume expansion rate.

It is found that, reducing a negative effect of volume expansion of silicon particles on a battery and improving conductivity of the silicon particles can improve initial Coulombic efficiency of a negative electrode plate, thereby improving cycling stability and rate performance of the battery, and reducing a volume expansion rate of the battery.

After further in-depth research, it is found that, to reduce a negative impact of volume expansion of silicon particles on a battery and improve conductivity of the silicon particles, a specific structure may be used to provide buffer space for volume expansion of the silicon particles, and a specific element may be introduced to improve the conductivity of the silicon particles, thereby improving initial Coulombic efficiency of a negative electrode plate, improving stability and rate performance of a battery, and reducing a volume expansion rate of the battery. After further in-depth research, it is discovered a specific structure that can provide buffer space for volume expansion of silicon particles and a metal element that can improve conductivity of the silicon particles.

To achieve the foregoing objectives, a first aspect of the present disclosure provides a negative electrode material, where the negative electrode material has a core-shell structure, a shell layer includes a carbon layer, a core includes porous carbon and silicon particles distributed in an outer pore of the porous carbon, the porous carbon further includes an inner pore, and the negative electrode material includes a metal element.

A second aspect of the present disclosure provides a negative electrode plate, where the negative electrode plate includes the negative electrode material according to the first aspect of the present disclosure.

A third aspect of the present disclosure provides a battery, where the battery includes the negative electrode material according to the first aspect of the present disclosure and/or the negative electrode plate according to the second aspect of the present disclosure.

Based on the foregoing technical solutions, the present disclosure has at least the following advantages compared with the conventional technology.

The negative electrode material in the present disclosure can provide buffer space when lithium intercalation volume expansion occurs on silicon particles.

The negative electrode material in the present disclosure has high stability on an interface with an electrolyte solution.

The negative electrode material in the present disclosure has high conductivity.

The negative electrode plate in the present disclosure has high specific capacity and high initial Coulombic efficiency.

The battery in the present disclosure has high cycling stability.

The battery in the present disclosure has good rate performance.

The battery in the present disclosure has low volume expansion rate.

Other features and advantages of the present disclosure will be detailed in the following specific embodiments.

### BRIEF DESCRIPTION OF THE DRAWINGS

FIG. 1 is a particle size-volume distribution diagram of the negative electrode materials in Example 1 and Example 5a in the present disclosure.

FIG. 2 shows first charge/discharge curves of the negative electrode materials in Example 1 and Example 2d in the present disclosure.

FIG. 3 is a schematic diagram of discharge curves of batteries prepared by using the negative electrode materials in Example 1 and Example 2c in different rates in the present disclosure.

FIG. 4 is a schematic diagram of capacity retention rate change curves formed after 500 cycles of batteries prepared by the negative electrode material in Example 1 and the conventional carbon-coated silicon carbon material in Comparative Example 1 in the present disclosure.

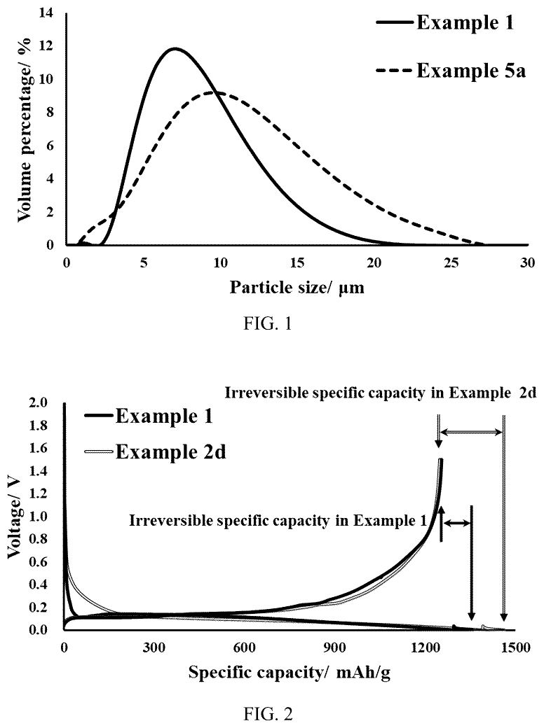

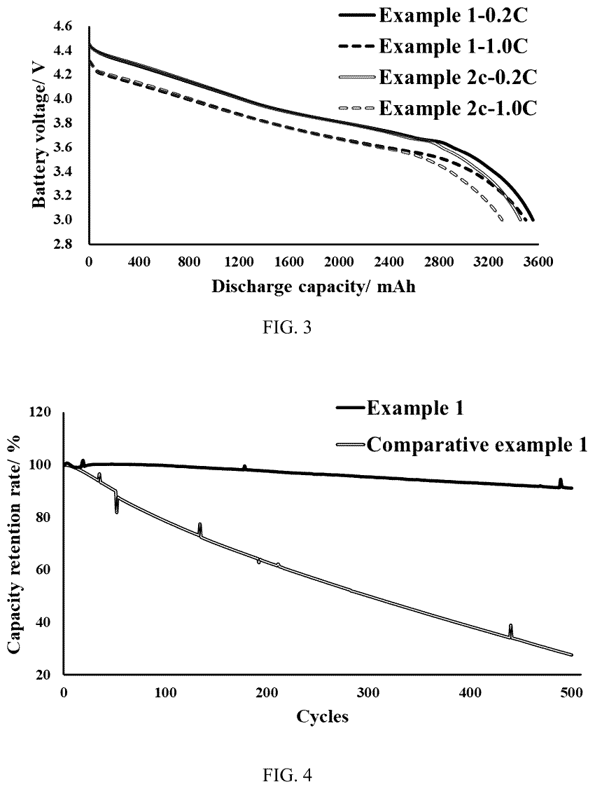

### DETAILED DESCRIPTION OF THE EMBODIMENTS

Specific implementations of the present disclosure are described below in detail. It should be understood that the specific implementations described herein are merely used for the purposes of illustrating and explaining the present disclosure, rather than limiting the present disclosure.

A first aspect of the present disclosure provides a negative electrode material, where the negative electrode material has a core-shell structure, a shell layer includes a carbon layer, a core includes porous carbon and silicon particles distributed in an outer pore of the porous carbon, the porous carbon further includes an inner pore, and the negative electrode material includes a metal element.

In existing preparation of a silicon-carbon composite material, a carbon coating layer is usually formed on a surface of silicon particles in a chemical vapor deposition manner or a polymer pyrolysis manner. However, even though the carbon coating layer formed in this manner is relatively compact at the beginning, the carbon coating layer expands together with an inner core in an expansion process of the silicon particles. When a silicon content in the composite material is relatively high, it is easy to cause the carbon coating layer to fall off or peel off from the surface of the silicon particles, resulting in that an electrolyte solution is directly in contact with the inner core of the silicon particles, and the electrolyte solution is reduced on the surface of the silicon particles to produce a passivation film. However, as cycling continues, the passivation film also ruptures and grows repeatedly with continuous expansion and contraction of the inner core of the silicon particle, which consumes active lithium in a battery and generates additional gas, thereby causing continuous capacity attenuation and an increase in thickness of the battery.

It is found that a part of hollow inner pores are left in silicon carbon composite particles, and the inner pores are used to buffer volume expansion during lithium intercalation of active silicon, to reduce an overall volume expansion rate of the silicon carbon composite particles, which helps maintain mechanical stability of a carbon coating layer on a surface of the silicon carbon composite particles and improve structural stability of a negative electrode material. A carbon layer is disposed on the surface of the silicon carbon composite particles, so that direct contact between an electrolyte solution and the active silicon can be prevented, improving stability of an interface between the negative electrode material and the electrolyte solution. In addition, introducing a metal element can improve electronic conductivity of the negative electrode material and improve dynamic performance of the negative electrode material, thereby improving cycling stability and rate performance of a battery including the negative electrode material.

In the present disclosure, in the foregoing manner, a negative effect of volume expansion of silicon particles on the battery is reduced, and conductivity of the silicon particles is improved, so that the negative electrode material can achieve better stability and higher conductivity than that in a conventional technology. To further enhance the effect, one or more of the technical features may be further optimized.

The negative electrode material has a core-shell structure, a shell layer includes a carbon layer, a core includes porous carbon and silicon particles distributed in an outer pore of the porous carbon, and the porous carbon further includes an inner pore, that is, a core includes silicon carbon composite particles having an inner pore.

In an example, the porous carbon includes an inner pore having an enclosed space.

The silicon carbon composite particles include porous carbon and silicon particles. The porous carbon has an outer pore and an inner pore, where the outer pore refers to an open space in communication with an outer surface of the porous carbon, and the inner pore refers to an enclosed space that is formed inside the porous carbon and that is not in communication with the outer surface of the porous carbon. In the silicon carbon composite particles, the silicon particles are distributed in the outer pore of the porous carbon, and the outer pore is partially or fully filled with the silicon particles.

Because the silicon carbon composite particles include porous carbon, and the porous carbon has the inner pore that forms an enclosed space, the silicon carbon composite particles also have an inner pore. The inner pore of the silicon carbon composite particles is inside the silicon carbon composite particle, and is a hollow part that is not filled with silicon, carbon, or another substance and that is not in communication with the outer surface of the silicon-carbon composite particles. Therefore, the inner pore can provide buffer space for volume expansion during lithium intercalation of the silicon particles, so as to avoid rupture and failure of the carbon layer serving as the shell layer caused because volume expansion of the core is too large. In addition, the inner pore is not in communication with the outer surface, so as to prevent an electrolyte solution from penetrating into the inner pore to be reduced at the hole wall of the inner pore and decomposed to produce a passivation film, thus avoiding that active lithium in a battery is consumed and a capacity of the battery is reduced.

The carbon layer may be partially or fully coated on the outer surface of the silicon carbon composite particles. When the carbon layer is partially coated on the outer surface of the silicon carbon composite particles, the carbon layer can at least cover the outer pore with the silicon particles distributed, so that the carbon layer serving as the shell layer can prevent the electrolyte solution from directly contacting the silicon particles, thereby improving stability of an interface between the negative electrode material and the electrolyte solution.

The negative electrode material includes a metal element, and the metal element may be in a form of a compound. The metal element introduced in the negative electrode material can improve conductivity of the negative electrode material, and improve initial Coulombic efficiency of the negative electrode material, so that a negative electrode plate has features of high specific capacity and high initial Coulombic efficiency.

According to a specific implementation, the metal element includes a first metal element and a second metal element.

In an example, the first metal element includes one or more of iron, nickel, manganese, copper, or calcium.

The first metal element may be in a form of a compound, for example, including one or more of iron oxide, nickel oxide, manganese oxide, copper oxide, or calcium oxide.

In an example, the second metal element includes lithium and/or sodium.

The second metal element may be in a form of a compound, for example, including one or more of lithium naphthalene-tetrahydrofuran or sodium naphthalene-tetrahydrofuran.

According to a specific implementation, a concentration of the first metal element at the core is higher than a concentration of the first metal element at the shell layer; and/or a concentration of the second metal element at the shell layer is higher than a concentration of the second metal element at the core.

In an example, the concentration of the first metal element at the core is higher than the concentration of the first metal element at the shell layer.

In an example, the concentration of the second metal element at the shell layer is higher than the concentration of the second metal element at the core.

In an example, the concentration of the first metal element at the core is higher than the concentration of the first metal element at the shell layer and the concentration of the second metal element at the shell layer is higher than the concentration of the second metal element at the core. When concentration distribution of the first metal element and the second metal element in the negative electrode material is as described above, distribution of the first metal element and the second metal element in the negative electrode material is relatively uniform, and overall conductivity of the negative electrode material is improved.

According to a specific implementation, a concentration of the first metal element in the negative electrode material gradually decreases in a direction from inside to outside; and/or a concentration of the second metal element in the negative electrode material gradually increases in a direction from inside to outside.

In an example, the concentration of the first metal element in the negative electrode material gradually decreases in a direction from inside to outside.

In an example, the concentration of the second metal element in the negative electrode material gradually increases in a direction from inside to outside.

In an example, in the negative electrode material, the concentration of the first metal element in the negative electrode material gradually decreases in a direction from inside to outside, and the concentration of the second metal element gradually increases in a direction from inside to outside. When the concentration distribution of the first metal element and the second metal element in the negative electrode material is as described above, distribution of the first metal element and the second metal element in the negative electrode material is more uniform, thereby further improving conductivity of the negative electrode material.

According to a specific implementation, a total weight of the negative electrode material being as a reference, a weight content c of the first metal element (M1) meets 0.001 wt %≤c≤1.5 wt % (for example, is 0.001 wt %, 0.005 wt %, 0.01 wt %, 0.05 wt %, 0.1 wt %, 0.5 wt %, 1 wt %, or 1.5 wt %), and a weight content d of the second metal element (M2) meets 0.001 wt %≤d≤5 wt % (for example, is 0.001 wt %, 0.005 wt %, 0.01 wt %, 0.05 wt %, 0.1 wt %, 0.5 wt %, 1 wt %, 2 wt %, 3 wt %, 4 wt %, or 5 wt %).

In an example, the total weight of the negative electrode material being as a reference, the weight content c of the first metal element meets 0.005 wt %≤c≤1 wt %.

In an example, the total weight of the negative electrode material being as a reference, the weight content d of the second metal element meets 0.005 wt %≤d≤2 wt %.

In the present disclosure, the weight content of the first metal element and the weight content of the second metal element may be tested by using an inductively coupled plasma atomic emission spectrometer (ICP-AES) method, for example, by using an inductively coupled plasma atomic emission spectrometer Macy ICP-6800. During the test, nitric acid and hydrofluoric acid are used for digestion. During each element test, calibration is performed by using a standard solution of a corresponding element. A test ambient temperature is 25±2° C., a plasma flow rate is 15 mL/min, and a sampling pump flow rate is 1.5 mL/min.

In an example, in the negative electrode material, a weight ratio of the first metal element to the second metal element is (0.05-10):1 (for example, is 0.05:1, 0.1:1, 0.5:1, 1:1, 2:1, 3:1, 4:1, 5:1, 6:1, 7:1, 8:1, 9:1, or 10:1). The weight ratio of the first metal element to the second metal element is limited in a specific range, so that conductivity of the negative electrode material can be improved through cooperation of the first metal element and the second metal element, thereby improving initial Coulombic efficiency of the negative electrode plate.

In an example, in the negative electrode material, a weight ratio of the first metal element to the second metal element is (0.1-5):1.

According to a specific implementation, a specific surface area of the porous carbon ranges from 500 m²/g to 2000 m²/g (for example, is 500 m²/g, 800 m²/g, 1000 m²/g, 1200 m²/g, 1500 m²/g, 1800 m²/g, or 2000 m²/g). Setting the specific surface area of the porous carbon in the foregoing specific range may improve stability of an interface between the negative electrode material and the electrolyte solution.

In an example, the specific surface area of the porous carbon ranges from 600 m²/g to 1600 m²/g.

In the present disclosure, the specific surface areas of the porous carbon and the negative electrode material may be tested by using a Brunauer-Emmett-Teller (BET) method. For example, a Tri StarII specific surface analyzer is used for measurement.

In an example, a median particle size Dᵥ50 of the porous carbon ranges from 5 μm to 12 μm (for example, is 5 μm, 6 μm, 7 μm, 8 μm, 9 μm, 10 μm, 11 μm, or 12 μm). Setting the median particle size of the porous carbon in the foregoing specific range may improve stability of the interface between the negative electrode material and the electrolyte solution.

In an example, a difference |Dᵥ90−Dᵥ10| between Dᵥ90 and Dᵥ10 of the porous carbon is greater than 1 μm and less than or equal to 12 μm (for example, is 2 μm, 3 μm, 4 μm, 5 μm, 6 μm, 7 μm, 8 μm, 9 μm, 10 μm, 11 μm, or 12 μm).

In an example, the porous carbon includes one or more of soft carbon, hard carbon, activated carbon, artificial graphite, or natural graphite.

In an example, the porous carbon includes one or more of soft carbon, hard carbon, or activated carbon.

In an example, a true density a of the negative electrode material ranges from 1.5 g/cm³ to 2.2 g/cm³ (for example, is 1.5 g/cm³, 1.6 g/cm³, 1.7 g/cm³, 1.8 g/cm³, 1.9 g/cm³, 2 g/cm³, 2.1 g/cm³, or 2.2 g/cm³). The true density of the negative electrode material meeting the foregoing specific range indicates that there are more inner pores in the negative electrode material, so that a carbon layer in the negative electrode material avoids breakage and failure caused by expansion of a core, and a content of silicon in the negative electrode material is high enough to enable the negative electrode material to have a relatively high specific capacity. The true density a of the negative electrode material being less than 1.5 g/cm³ indicates that there are more unfilled inner pores in the negative electrode material. In this case, the content of silicon in the negative electrode material is relatively low, and therefore, the specific capacity of the negative electrode material is relatively low. The true density a of the negative electrode material being greater than 2.2 g/cm³ indicates that there are few inner pores in the negative electrode material. In this case, when lithium intercalation volume expansion occurs on active silicon in the negative electrode material, the carbon layer is easily deformed and destroyed, resulting in reduced structural stability of the negative electrode material.

In a preferred example, the true density a of the negative electrode material ranges from 1.65 g/cm³ to 2.05 g/cm³.

In the present disclosure, the true density of the negative electrode material may be tested using a gas volume displacement method. For example, a TOB-JW-M100A fully automatic true density tester is used for test, a test gas is helium, and a test ambient temperature is 25±2° C.

In an example, a total weight of the negative electrode material being as a reference, a weight content b of a silicon element ranges from 35 wt % to 75 wt % (for example, is 35 wt %, 40 wt %, 45 wt %, 50 wt %, 55 wt %, 60 wt %, 65 wt %, 70 wt %, or 75 wt %). The weight content of the silicon element in the negative electrode material meeting the foregoing specific range indicates that the negative electrode material may exert a relatively high specific capacity, and a relatively large quantity of inner pores in the negative electrode material can provide sufficient buffer space for expansion of silicon particles. When the weight content b of the silicon element in the negative electrode material is less than 35%, the content of the silicon element in the negative electrode material is too low, and the specific capacity of the negative electrode material is relatively low; when the weight content b of the silicon element in the negative electrode material is greater than 75%, there is a large quantity of silicon in the negative electrode material, buffer space provided by inner pores in the carbon material is insufficient, and lithium intercalation expansion of the core of the negative electrode material will be large, which may cause structural failure of the negative electrode material.

In a preferred example, the total weight of negative electrode material being used as a reference, the weight content b of the silicon element ranges from 45 wt % to 60 wt %.

In the present disclosure, the weight content of the silicon element may be tested by using a material X-ray fluorescence (XRF) or energy dispersive spectroscopy (EDS) analysis method, for example, by using a Thermo Fisher X-ray fluorescence spectrometer or an Oxford energy dispersive spectrometer.

In an example, a particle size Dᵥ90 of the negative electrode material ranges from 10 μm to 22μ m (for example, is 10μ, 11 μm, 12 μm, 13 μm, 14μ, 15μ, 16 μm, 17 μm, 18 μm, 19 μm, 20 μm, 21 μm, or 22 μm).

In an example, a particle size Dᵥ10 of the negative electrode material ranges from 1 μm to 9 μm (for example, is 1 μm, 2 μm, 3 μm, 4 μm, 5 μm, 6 μm, 7 μm, 8 μm, or 9 μm).

According to a specific implementation, a difference e=|Dᵥ90−Dᵥ10| between particle sizes Dᵥ90 and Dᵥ10 of the negative electrode material meets 1 μm≤e≤12 μm (for example, is 2 μm, 3 μm, 4 μm, 5 μm, 6 μm, 7 μm, 8 μm, 9 μm, 10 μm, 11 μm, or 12 μm). The difference e between the particle sizes Dᵥ90 and the Dᵥ10 of the negative electrode material meeting the foregoing specific range indicates that particle size distribution of the negative electrode material is relatively concentrated, which is beneficial for a battery including a negative electrode plate including the negative electrode material to exert a higher volume energy density. The difference e being greater than 12 μm indicates that the negative electrode material is mostly formed by small particle size particles or large particle size particles. The small particle size particles have a relatively large specific surface area, which consumes a relatively large amount of active lithium in a first cycle of a charging process of a battery, causing a relatively low actual capacity of the battery. The large particle size particles cause a relatively low accumulation density of the negative electrode material in the negative electrode plate, and thus a battery including the negative electrode plate of the negative electrode material is relatively thick and a volume energy density of the battery is relatively low. In addition, distribution of a relatively large amount of large particle size particles causes a relatively long diffusion path of lithium ion and a relatively poor dynamic performance.

In a preferred example, the difference e=|Dᵥ90−Dᵥ10| between particle sizes Dᵥ90 and Dᵥ10 of the negative electrode material meets 5 μm≤e≤10 μm.

In an example, a median particle size Dᵥ50 of the negative electrode material ranges from 5 μm to 12 μm (for example, is 5 μm, 6 μm, 7 μm, 8 μm, 9 μm, 10 μm, 11 μm, or 12 μm). Setting the median particle size of the negative electrode material in the foregoing specific range may improve stability of the interface between the negative electrode material and the electrolyte solution.

In the present disclosure, DᵥN (for example, Dᵥ10, Dᵥ50, or Dᵥ90) refers to a particle size below which N % of a sample volume is found in cumulative volume particle size distribution. Specifically, Dᵥ10 is a particle size measured when a volume of particles less than or equal to this particle size accounts for 10% of a total volume of particles; Dᵥ50 is a particle size measured when a volume of particles less than or equal to this particle size accounts for 50% of a total volume of particles; and Dᵥ90 is a particle size measured when a volume of particles less than or equal to this particle size accounts for 90% of a total volume of particles.

In the present disclosure, median particle sizes Dᵥ10, Dᵥ50, and Dᵥ90 of the negative electrode material may be tested by using a laser particle size test method. For example, a Malvern particle size analyzer is used for measurement. A test procedure is as follows: dispersing the negative electrode material in deionized water including a dispersing agent (for example, nonylphenol polyoxyethylene ether, with a content ranging from 0.02 wt % to 0.03 wt %) to form a mixture, ultrasonicating the mixture for 2 minutes, and then putting the mixture into a Malvern particle size analyzer for test.

In an example, a specific surface area of the negative electrode material ranges from 0.5 m²/g to 20 m²/g (for example, is 0.5 m²/g, 1 m²/g, 3 m²/g, 5 m²/g, 8 m²/g, 10 m²/g, 12 m²/g, 15 m²/g, 17 m²/g, or 20 m²/g). Setting the specific surface area of the negative electrode material in the foregoing specific range may improve stability of the interface between the negative electrode material and the electrolyte solution.

The negative electrode material may be prepared by using the following method.

S1, soaking a porous carbon material in a dispersion including a catalyst, and removing the solvent to obtain a porous carbon material loaded with a first metal element, where the catalyst includes a compound including the first metal element.

S2, contacting the porous carbon material with silane gas, increasing a temperature to crack silane to generate silicon particles, and depositing the silicon particles in pores of the porous carbon, to obtain silicon carbon composite particles as a core.

S3, contacting the silicon carbon composite particles with acetylene gas, raising the temperature to crack the acetylene gas to generate carbon particles, and depositing the carbon particles on a surface of the silicon carbon composite particles to form a carbon layer, to obtain a carbon-coated silicon-carbon composite material.

S4, performing modification processing on the carbon-coated silicon-carbon composite material by using a modifying reagent, and doping a second metal element into the carbon-coated silicon-carbon composite material, where the modifying reagent includes a compound that includes the second metal element.

In an example, the porous carbon material includes one or more of soft carbon, hard carbon, activated carbon, artificial graphite, or natural graphite.

In an example, a compound including the first metal element includes one or more of iron oxide, nickel oxide, manganese oxide, copper oxide, or calcium oxide.

In an example, the silane gas includes one or more of monosilane, trichlorosilane, or trifluorosilane.

In an example, conditions for silane cracking include a temperature of ranging from 400° C. to 700° C. (for example, is 400° C., 450° C., 500° C., 550° C., 600° C., 650° C., or 700° C.) and a time of ranging from 4 h to 12 h (for example, is 4 h, 5 h, 6 h, 7 h, 8 h, 9 h, 10 h, 11 h, or 12 h).

In an example, conditions for silane cracking include a temperature of ranging from 500° C. to 600° C. and a time of ranging from 6 h to 10 h.

In an example, conditions for acetylene gas cracking include a temperature of ranging from 500° C. to 900° C. (for example, is 500° C., 550° C., 600° C., 650° C., 700° C., 750° C., 800° C., 850° C., or 900° C.) and a time of ranging from 0.5 h to 5 h (for example, is 0.5 h, 1 h, 2 h, 3 h, 4 h, or 5 h).

In an example, conditions for acetylene gas cracking include a temperature of ranging from 700° C. to 900° C. and a time ranging from 0.5 h to 3 h.

In an example, the compound including the second metal element includes one or more of lithium naphthalene-tetrahydrofuran or sodium naphthalene-tetrahydrofuran. The modifying reagent may be in a form of a solution.

A second aspect of the present disclosure provides a negative electrode plate, where the negative electrode plate includes the negative electrode material according to the first aspect of the present disclosure.

Except for the negative electrode material in the negative electrode active material layer, all materials of the negative electrode plate may be prepared in a manner in the art, and both effects of high specific capacity and high initial Coulombic efficiency can be achieved.

In an example, the negative electrode plate includes a negative electrode current collector and a negative electrode active material layer coated on at least one side surface of the negative electrode current collector, and the negative electrode active material layer includes the negative electrode material.

According to a specific implementation, the negative electrode active material layer further includes graphite.

In an example, the graphite is artificial graphite and/or natural graphite.

In an example, a total weight of the negative electrode active material layer being used as a reference, a weight content of the negative electrode material ranges from 0.5 wt % to 99 wt % (for example, is 0.5 wt %, 1 wt %, 5 wt %, 10 wt %, 20 wt %, 30 wt %, 40 wt %, 50 wt %, 60 wt %, 70 wt %, 80 wt %, 90 wt %, or 99 wt %).

In an example, the total weight of the negative electrode active material layer being used as a reference, the weight content of the negative electrode material ranges from 48 wt % to 95 wt %.

In an example, the total weight of the negative electrode active material layer being used as a reference, a weight content of the graphite ranges from 0 wt % to 98.5 wt % (for example, is 0 wt %, 1 wt %, 5 wt %, 10 wt %, 20 wt %, 30 wt %, 40 wt %, 50 wt %, 60 wt %, 70 wt %, 80 wt %, 90 wt %, or 98.5 wt %). The weight content of the graphite being 0 wt % indicates that the negative electrode active material layer does not include graphite.

In an example, the total weight of the negative electrode active material layer being used as a reference, the weight content of the graphite ranges from 1 wt % to 50 wt %.

According to a specific implementation, the negative electrode active material layer includes a conductive agent and a binder.

In an example, the conductive agent includes one or more of carbon black, acetylene black, Keqin black, carbon fiber, single-walled carbon nanotube, or multi-wall carbon nanotube.

In an example, the binder includes one or more of carboxymethyl cellulose, sodium carboxymethyl cellulose, lithium carboxymethyl cellulose, hydroxypropyl cellulose, diacetyl cellulose, polyethylene, polyvinyl alcohol, polyvinyl chloride, polyvinyl fluoride, polyvinylpyrrolidone, polytetrafluoroethylene, polypropylene, styrene-butadiene rubber, or epoxy resin.

In an example, the total weight of the negative electrode active material layer being used as a reference, a weight content of the conductive agent ranges from 0.5 wt % to 15 wt % (for example, is 0.5 wt %, 1 wt %, 3 wt %, 5 wt %, 8 wt %, 10 wt %, 12 wt %, or 15 wt %) and a weight content of the binder ranges from 0.5 wt % to 15 wt % (for example, is 0.5 wt %, 1 wt %, 3 wt %, 5 wt %, 8 wt %, 10 wt %, 12 wt %, or 15 wt %).

In an example, the total weight of the negative electrode active material layer being used as a reference, the weight content of the conductive agent ranges from 1 wt % to 10 wt %, and the weight content of the binder ranges from 1 wt % to 10 wt %.

In an example, the negative electrode current collector includes one or more of copper foil, copper foil coated with carbon, or perforated copper foil.

The negative electrode plate may be prepared by using a conventional method, or may be prepared by using the following method: mixing the negative electrode material, the conductive agent, the binder, and optional graphite into deionized water, to obtain a negative electrode slurry, applying the negative electrode slurry onto a surface on at least one side of the negative electrode current collector, performing slicing after baking, then putting the obtained slices into a vacuum oven for drying, and finally performing roll-pressing and cutting to obtain the negative electrode plate.

The negative electrode plate of the present disclosure includes a negative active material layer of the negative electrode material of the present disclosure, so that initial Coulombic efficiency of the negative electrode plate is improved.

A third aspect of the present disclosure provides a battery, where the battery includes the negative electrode material according to the first aspect of the present disclosure and/or the negative electrode plate according to the second aspect of the present disclosure.

Except for the negative electrode plate, all materials of the battery may be prepared in a manner in the art, and effects of high cycling stability, good rate performance, and low volume expansion rate can be achieved.

The battery may include a lithium-ion battery.

The battery may include a lithium-ion secondary battery.

In an example, the battery includes a positive electrode plate, a separator, and an electrolyte solution.

In an example, the positive electrode plate includes a positive electrode current collector and a positive electrode active material layer coated on at least one surface of the positive electrode current collector, and the positive electrode active material layer includes a positive electrode material.

In an example, the positive electrode current collector includes one or more of aluminum foil, aluminum foil coated with carbon, or perforated aluminum foil.

In an example, the positive electrode material includes one or more of lithium iron phosphate, lithium manganese phosphate, lithium vanadium phosphate, lithium iron silicate, lithium cobalt oxide, a nickel cobalt manganese ternary material, a nickel-manganese/cobalt-manganese/nickel-cobalt binary material, lithium manganese oxide, or a lithium-rich manganese-based material.

In an example, the separator includes one or more of polyethylene or polypropylene.

In an example, the electrolyte solution is a non-aqueous electrolyte solution.

In an example, the electrolyte solution includes a cacrbonic acid ester solvent and a lithium salt.

In an example, the cacrbonic acid ester solvent includes one or more of ethylene carbonate (EC), propylene carbonate (PC), diethyl carbonate (DEC), fluoroethylene carbonate (FEC), dimethyl carbonate (DMC), or ethyl methyl carbonate (EMC).

In an example, the lithium salt is selected from one or more of LiPF₆, LiBF₄, LiSbF₆, LiClO₄, LiCF₃SO₃, LiAlO₄, LiAlCl₄, Li(CF₃SO₂)₂N, LiBOB, or LiDFOB.

In an example, a housing of the battery includes one of an aluminum-plastic film, aluminum alloy, or stainless steel.

The battery in the present disclosure includes the negative electrode plate according to the present disclosure, so that cycling stability of the battery is improved, rate performance is improved, and a volume expansion rate is reduced.

The following describes the present disclosure in detail by using embodiments. The embodiments described in the present disclosure are merely some, but not all of the embodiments of the present disclosure. All other embodiments obtained by a person of ordinary skill in the art based on embodiments of the present disclosure without creative efforts fall within the protection scope of the present disclosure.

The following examples are used to describe the negative electrode material in the present disclosure.

### Example 1

### (1) Preparation of Raw Materials

Porous carbon material: 30 g activated carbon with a specific surface area of 1000 m²/g and a median particle size Dᵥ50 of 6.2 μm, where |Dᵥ90−Dᵥ10|=8.2 μm;

Catalyst: 0.5 g compound (iron oxide) including the first metal element;

Silane gas: silane;

Acetylene gas; and

Modifying reagent: a compound (lithium naphthalene-tetrahydrofuran) including the second metal element.

### (2) Preparation of a Negative Electrode Material

The porous carbon material was added to an aqueous dispersion including nanoscale iron oxide, and the mixture was fully stirred and heated to remove the water solvent, to obtain a porous carbon material loaded with nanoscale iron oxide. The obtained porous carbon material loaded with nanoscale iron oxide was placed in a vapor deposition furnace, and the silane gas with a flow rate of 300 sccm was introduced. Subsequently, a temperature was raised to 550° C. to crack the silane, and the cracking time was controlled to be 6 h. After completion of the cracking, the introduction of the silane was stopped, the temperature was raised to 800° C., and the acetylene gas with a flow rate of 100 sccm was introduced. An acetylene cracking time was controlled to be 1 h, to obtain a carbon-coated silicon-carbon composite material. The obtained carbon-coated silicon-carbon composite material was soaked in 100 mL of 0.01 mol/L lithium naphthalene-tetrahydrofuran solution for 0.5 h, then centrifugally cleaned with ethylene glycol dimethyl ether as a cleaning solvent, and dried to obtain the negative electrode material (for performance parameters of the negative electrode material, refer to Table 1).

### Group of Examples 2

This example group is used to describe an impact produced when a metal element changes.

### Example 2a

For this example, reference was made to Example 1. A difference lies in that the compound that includes the first metal element is adjusted to copper oxide. For performance parameters of the negative electrode material, refer to Table 1.

### Example 2b

For this example, reference was made to Example 1. A difference lies in that the compound that includes the second metal element is adjusted to sodium naphthalene-tetrahydrofuran. For performance parameters of the negative electrode material, refer to Table 1.

### Example 2c

For this example, reference was made to Example 1. A difference lies in that the compound including the first metal element is not added. For performance parameters of the negative electrode material, refer to Table 1.

### Example 2d

For this example, reference was made to Example 1. A difference lies in that the compound including the second metal element is not added. For performance parameters of the negative electrode material, refer to Table 1.

### Group of Examples 3

This example group is used to describe an impact produced when concentration distribution of a metal element changes.

### Example 3a

For this example, reference was made to Example 1. A difference lies in that the step of introducing the first metal element is performed before the step of introducing the second metal element, that is, iron oxide was introduced after acetylene cracking. For performance parameters of the negative electrode material, refer to Table 1.

### Example 3b

For this example, reference was made to Example 1. A difference lies in that the step of introducing the second metal element is performed before the step of putting the porous carbon material in the vapor deposition furnace and introducing the silane gas. For performance parameters of the negative electrode material, refer to Table 1.

### Example 3c

For this example, reference was made to Example 1. A difference lies in that the time of soaking in lithium naphthalene-tetrahydrofuran solution is adjusted to 0.1 h. For performance parameters of the negative electrode material, refer to Table 1.

### Example 3d

For this example, reference was made to Example 1. A difference lies in that the compound (iron oxide) that includes the first metal element is adjusted to 0.1 g. For performance parameters of the negative electrode material, refer to Table 1.

### Example 3e

For this example, reference was made to Example 1. A difference lies in that the time of soaking in the lithium naphthalene-tetrahydrofuran solution is adjusted to 0.25 h. For performance parameters of the negative electrode material, refer to Table 1.

### Group of Examples 4

This example group is used to illustrate an impact produced when a true density of the negative electrode material and/or a weight content of the silicon element changes due to a change of a silane cracking time.

### Example 4a

For this example, reference was made to Example 1. A difference lies in that the silane cracking time is adjusted to 10 h. For performance parameters of the negative electrode material, refer to Table 1.

### Example 4b

For this example, reference was made to Example 1. A difference lies in that the silane cracking time is adjusted to 2 h. For performance parameters of the negative electrode material, refer to Table 1.

### Example 4c

For this example, reference was made to Example 1. A difference lies in that the silane cracking time is adjusted to 4 h. For performance parameters of the negative electrode material, refer to Table 1.

### Example 4d

For this example, reference was made to Example 1. A difference lies in that the silane cracking time is adjusted to 12 h. For performance parameters of the negative electrode material, refer to Table 1.

### Example 5

This example group is used to illustrate an impact produced when the difference |Dᵥ90−Dᵥ10| of the porous carbon material changes.

### Example 5a

For this example, reference was made to Example 1. A difference lies in that the difference |Dᵥ90−Dᵥ10| of the porous carbon material is adjusted to 11.2 μm. For performance parameters of the negative electrode material, refer to Table 1.

### Example 5b

For this example, reference was made to Example 1. A difference lies in that the difference |Dᵥ90−Dᵥ10| of the porous carbon material is adjusted to 3.4 μm. For performance parameters of the negative electrode material, refer to Table 1.

### Example 5c

For this example, reference was made to Example 1. A difference lies in that a difference Dᵥ90−Dᵥ10| of the porous carbon material is adjusted to 5.8 μm. For performance parameters of the negative electrode material, refer to Table 1.

### Example 5d

For this example, reference was made to Example 1. A difference lies in that a difference |Dᵥ90−Dᵥ10| of the porous carbon material is adjusted to 13.1 μm. For performance parameters of the negative electrode material, refer to Table 1.

### Example 5e

For this example, reference was made to Example 1. A difference lies in that a difference |Dᵥ90-Dᵥ10| of the porous carbon material is adjusted to 0.7 μm. For performance parameters of the negative electrode material, refer to Table 1.

### Comparative Example 1

30 g of commercialized 100 nm silicon particle powder was placed in a vapor deposition furnace, the temperature was raised to 800° C., then acetylene gas with a flow rate of 100 sccm was introduced, and an acetylene cracking time was controlled to be 2 h, to obtain a conventional carbon-coated silicon carbon material.

### Comparative Example 2

For this comparative example, reference was made to Example 1. A difference lies in that the porous carbon material has no inner pore that forms an enclosed space. For performance parameters of the negative electrode material, refer to Table 1.

### Comparative Example 3

For this comparative example, reference was made to Example 1. A difference lies in that the compound including the first metal element and the compound including the second metal element are not added. For performance parameters of the negative electrode material, refer to Table 1.

TABLE 1

| | | | | | | | | | Weight | |
|---|---|---|---|---|---|---|---|---|---|---|
| | | | | | | | | | ratio of | |
| | | | | | | | | | the first | Difference |
| | | | | Difference | | | | | metal | e = \|Dᵥ90 − |
| | Compound | Compound | | \|Dᵥ90 − | | Weight | | | element | Dᵥ10\| of |
| | including | including | | Dᵥ10\| of | | content | Weight | Weight | to the | the |
| | the first | the second | Silane | the porous | True | b of | content | content | second | negative |
| | metal | metal | cracking | carbon | density | silicon | c of | d of | metal | electrode |
| | element | element | time | material | a | element | M1 | M2 | element | material |
| Example 1 | Iron oxide | lithium | 6 h | 8.2 μm | 1.93 g/cm³ | 51.3% | 0.83% | 1.62% | 0.51:1 | 8.31 μm |
| | | naphthalene- | | | | | | | | |
| | | tetrahydrofuran | | | | | | | | |
| Example 2a | Copper | * | * | * | 1.95 g/cm³ | 53.7% | 0.79% | 1.47% | 0.54:1 | 8.56 μm |
| | oxide | | | | | | | | | |
| Example 2b | * | Sodium | * | * | 1.91 g/cm³ | 53.9% | 0.77% | 1.18% | 0.65:1 | 8.54 μm |
| | | naphthalate- | | | | | | | | |
| | | tetrahydrofuran | | | | | | | | |
| Example 2c | — | * | * | * | 2.05 g/cm³ | 47.5% | 0% | 1.01% | — | 8.30 μm |
| Example 2d | * | — | * | * | 1.99 g/cm³ | 50.2% | 0.96% | 0% | — | 8.47 μm |
| Example 3a | * | * | * | * | 2.03 g/cm³ | 47.3% | 0.99% | 1.77% | 0.56:1 | 8.42 μm |
| Example 3b | * | * | * | * | 2.04 g/cm³ | 47.7% | 0.87% | 0.96% | 0.91:1 | 8.41 μm |
| Example 3c | * | * | * | * | 2.02 g/cm³ | 47.2% | 0.99% | 0.09% | 11:1 | 8.40 μm |
| Example 3d | * | * | * | * | 2.03 g/cm³ | 47.4% | 0.12% | 1.5% | 0.08:1 | 8.43 μm |
| Example 3e | * | * | * | * | 2.01 g/cm³ | 47.1% | 1.0% | 0.15% | 6.67:1 | 8.42 μm |
| Example 4a | * | * | 10 h | * | 2.01 g/cm³ | 57.6% | 0.51% | 0.98% | 0.52:1 | 9.23 μm |
| Example 4b | * | * | 2 h | * | 1.54 g/cm³ | 40.1% | 0.98% | 1.94% | 0.51:1 | 8.29 μm |
| Example 4c | * | * | 4 h | * | 1.74 g/cm³ | 46.50% | 0.72% | 1.01% | 0.71:1 | 8.3 μm |
| Example 4d | * | * | 12 h | * | 2.15 g/cm³ | 59.50% | 0.64% | 0.91% | 0.70:1 | 9.29 μm |
| Example 5a | * | * | * | 11.2 μm | 1.82 g/cm³ | 51.4% | 0.86% | 1.73% | 0.5:1 | 11.42 μm |
| Example 5b | * | * | * | 3.4 μm | 1.91 g/cm³ | 50.9% | 0.79% | 1.64% | 0.48:1 | 3.67 μm |
| Example 5c | * | * | * | 5.8 μm | 1.89 g/cm³ | 51.0% | 0.83% | 1.59% | 0.52:1 | 5.93 μm |
| Example 5d | * | * | * | 13.1 μm | 1.80 g/cm³ | 50.3% | 0.85% | 1.57% | 0.54:1 | 13.10 μm |
| Example 5e | * | * | * | 0.7 μm | 1.99 g/cm³ | 51.2% | 0.82% | 1.60% | 0.52:1 | 0.92 μm |
| Comparative | — | — | — | — | 2.38 g/cm³ | 54.8% | 0% | 0% | — | 0.11 μm |
| Example 1 | | | | | | | | | | |
| Comparative | * | * | * | * | 2.47 g/cm³ | 49.5% | 0.43% | 1.96% | 0.22:1 | 9.17 μm |
| Example 2 | | | | | | | | | | |
| Comparative | — | — | * | * | 1.76 g/cm³ | 48.3% | 0% | 0% | — | 8.25 μm |
| Example 3 | | | | | | | | | | |

* indicates that the value is the same as that in Example 1.
— indicates non-existent.

### Preparation Example

### 1. Preparation of a Button Half-Cell

The negative electrode materials obtained according to the examples and comparative examples were separately used to prepare a button half-cell in the following manner.
(1) A negative electrode material obtained according to an example or a comparative example, artificial graphite, SuperP, sodium carboxymethyl cellulose, and styrene-butadiene rubber were mixed according to a mass ratio of 50:46.5:1.6:1.6:0.3, deionized water was added, and the mixture was stirred evenly under the action of a vacuum mixer to obtain a negative electrode slurry.
(2) The negative electrode slurry in step (1) was applied on copper foil and dried in an oven at 80° C., and then transferred to a vacuum oven at 100° C. for drying 12 hours, to obtain a negative electrode plate with a surface density of about 6 mg/cm².
(3) In a drying environment, the negative electrode plate obtained in step (2) was rolled with a compaction of about 1.3 g/cm³, and then a negative electrode wafer with a diameter of 12 mm was made by a punching machine.
(4) In a glove box, the negative electrode wafer in step (3) was used as a working electrode, a metal lithium plate was used as a counter electrode, a polyethylene separator with a thickness of 20 μm was used as a separation film, and an electrolyte solution was added to assemble the button half-cell.

### 2. Preparation of a Lithium-Ion Battery

The negative electrode materials obtained according to the examples and the comparative examples were separately used to prepare a lithium-ion battery in the following manner.

### (1) Preparation of a Negative Electrode Plate

A negative electrode material obtained according to an example or a comparative example, artificial graphite, Super P, sodium carboxymethyl cellulose and styrene-butadiene rubber were mixed according to a mass ratio of 50:46.5:1.6:1.6:0.3, deionized water was added, and the mixture was stirred evenly under the action of a vacuum mixer, to obtain a negative electrode slurry. The negative electrode slurry was evenly applied on copper foil having a thickness of 8 μm, where a surface density of the negative electrode slurry on a surface of a negative electrode current collector is 11 mg/cm². The copper foil was transferred to an oven at 80° C. for drying 12 hours, followed by roll-pressing and cutting, to obtain the negative electrode plate.

### (2) Preparation of a Positive Electrode Plate

Lithium cobalt oxide (LCO), polyvinylidene fluoride (PVDF), acetylene black and carbon nanotube (CNTs) were mixed according to a mass ratio 96:2:1.5:0.5, and N-methylpyrrolidone was added. The mixture was stirred under action of a vacuum mixer until a mixture was mixed evenly, to obtain a positive electrode slurry. The positive electrode slurry was evenly applied on aluminum foil with a thickness of 12 μm. The coated aluminum foil was baked in an oven, and then dried in an oven at 120° C. for drying 8 hours, followed by roll-pressing and cutting, to obtain the required positive electrode plate. A size of the positive electrode plate is less than that of the negative electrode plate, and a reversible capacity per unit area of the positive electrode plate is 4% less than that of the negative electrode plate.

### (3) Separator

A polyethylene separator with a thickness of 8 μm was selected.

### (4) Preparation of a Lithium-Ion Battery

The positive electrode plate in step (2), the separator in step (3), and the negative electrode plate in step (1) were sequentially stacked to ensure that the separator was located between the positive electrode plate and the negative electrode plate for separation, and then winding was performed to obtain a bare cell. The bare cell was placed in an aluminum-plastic film housing, an electrolyte solution was injected into the dried bare cell, and after processes such as vacuum packaging, standing, forming, shaping, and sorting, the required battery was obtained.

### Test Example

The button half-cells and the lithium-ion batteries obtained according to the examples and comparative examples were separately tested.

### 1. Performance Test for the Button Half-Cells

A land (LAND) test system was used to test the performance of the button half-cells obtained according to the examples and comparative examples. A test temperature was 25° C. Details are as follows.

### (1) Specific Capacity Test

Lithium intercalation was performed at a current of 0.1 mA to 0.005 V, and a button half-cell was set aside for 10 minutes. Lithium intercalation was performed at a current of 0.05 mA to 0.005 V, and the button half-cell was set aside for 10 minutes. Then lithium deintercalation was performed at a current of 0.1 mA to 1.5 V. An initial lithium intercalation and deintercalation capacity was obtained. A specific capacity of the negative electrode material was obtained by dividing the initial lithium intercalation and deintercalation capacity by the mass of the negative electrode material in the foregoing negative electrode wafer. Test results are shown in Table 2.

### (2) Initial Coulombic Efficiency Test

An initial Coulombic efficiency of the negative electrode plate including the negative electrode material was obtained by dividing an initial lithium deintercalation capacity by an initial lithium intercalation capacity. Test results are shown in Table 2.

### 2. Performance Test for the Lithium-Ion Battery

A land (LAND) test system was used to test the performance of the lithium-ion batteries obtained according to the examples and comparative examples. A test temperature was 25° C.

### (1) Energy Density Test

A battery was charged to 4.45 V at a constant current of 0.7C, charged to 0.05C at a constant voltage, and set aside for 10 minutes. The battery was discharged to 3.0 V at 0.2C, to obtain a discharge capacity. The discharge capacity was used as a nominal capacity. The nominal capacity was multiplied by an average discharge voltage to obtain battery energy, and the battery energy was divided by a battery volume, to obtain a battery energy density. Test results are shown in Table 2.

### (2) Capacity Retention Rate Test and Volume Expansion Rate Test

A battery was charged at a constant current of 1.5C to 4.45 V, charged at a constant voltage to 0.05C, and set aside for 10 minutes. The battery was discharged at 1C to 3.0 V, and set aside for 10 minutes. The charging/discharging steps were repeated in a cycle. A maximum discharge capacity in first three cycles was used as an initial battery capacity, and a ratio of a capacity after 500 cycles to the initial capacity was used as a capacity retention rate of the battery.

The battery was charged to 3.85 V at a constant current of 0.7C, and charged to 0.01C at a constant voltage. A thickness of the battery in this time was measured and used as an initial thickness of the battery. A thickness of the battery after 500 cycles was measured, and a volume expansion rate of the battery was obtained by dividing a difference between the thickness and the initial thickness by the initial thickness. Test results are shown in Table 2.

### (3) Test of a Ratio of 1 C Discharge Capacity to 0.2C Discharge Capacity

The battery was charged at a constant current of 0.7C to 4.45 V, charged at a constant voltage to 0.05C, and set aside for 10 minutes. The battery was discharged at 0.2C to 3.0 V, and set aside for 10 minutes. The charging/discharging steps were repeated for three cycles. Then the battery was charged to 4.45 V at a constant current of 0.7C, charged to 0.05C at a constant voltage, and set aside for 10 minutes. The battery was discharged to 3.0 V at 1C, and set aside for 10 minutes. The charging/discharging steps were repeated for three cycles. A maximum discharge capacity of the first three cycles was 0.2C, and a maximum discharge capacity of the last three cycles was 1C. Test results are shown in Table 2.

Results obtained were recorded in Table 2.

TABLE 2

| | | | | | | | Ratio of 1 C |
|---|---|---|---|---|---|---|---|
| | | | | | Capacity | Volume | discharge |
| | | | | | retention | expansion | capacity |
| | Specific | Initial | Nominal | Energy | rate after | rate after | to 0.2 C |
| | capacity | Coulombic | capacity | density | 500 | 500 | discharge |
| | (mAh/g) | efficiency | (mAh) | (Wh/L) | cycles | cycles | capacity |
| Example 1 | 1255.4 | 92.44% | 3554 | 830 | 91.07% | 8.30% | 98.44% |
| Example 2a | 1286.7 | 92.71% | 3585 | 833 | 91.04% | 8.41% | 98.37% |
| Example 2b | 1293.1 | 92.92% | 3592 | 835 | 91.03% | 8.48% | 98.33% |
| Example 2c | 1189.5 | 87.46% | 3453 | 806 | 85.37% | 9.07% | 95.73% |
| Example 2d | 1248.4 | 87.29% | 3473 | 807 | 83.59% | 9.06% | 96.02% |
| Example 3a | 1154.3 | 85.74% | 3401 | 796 | 80.49% | 10.17% | 94.38% |
| Example 3b | 1136.9 | 84.18% | 3396 | 791 | 81.64% | 10.08% | 94.91% |
| Example 3c | 1050.0 | 80.22% | 3255 | 778 | 76.42% | 11.22% | 94.20% |
| Example 3d | 1132.1 | 84.07% | 3392 | 790 | 78.50% | 11.01% | 92.04% |
| Example 3e | 1130.5 | 84.03% | 3393 | 790 | 79.87% | 10.95% | 94.55% |
| Example 4a | 1342.0 | 92.15% | 3571 | 830 | 90.59% | 8.98% | 98.15% |
| Example 4b | 1146.1 | 88.52% | 3395 | 802 | 86.49% | 9.79% | 96.30% |
| Example 4c | 1202.6 | 90.11% | 3465 | 819 | 89.52% | 9.41% | 97.65% |
| Example 4d | 1365 | 92.06% | 3605 | 839 | 89.16% | 9.97% | 97.82% |
| Example 5a | 1222.8 | 89.38% | 3492 | 809 | 84.68% | 9.95% | 95.48% |
| Example 5b | 1203.9 | 91.06% | 3487 | 802 | 87.02% | 9.13% | 96.72% |
| Example 5c | 1249.3 | 92.23% | 3553 | 829 | 91.04% | 8.31% | 98.56% |
| Example 5d | 1204.5 | 88.47% | 3486 | 801 | 84.05% | 9.98% | 94.79% |
| Example 5e | 1213.4 | 89.22% | 3489 | 803 | 83.77% | 10.24% | 94.87% |
| Comparative | 1281.2 | 78.27% | 3528 | 821 | 27.23% | 27.61% | 85.17% |
| Example 1 | | | | | | | |
| Comparative | 1194.5 | 84.92% | 3479 | 799 | 53.47% | 19.29% | 88.01% |
| Example 2 | | | | | | | |
| Comparative | 1195.3 | 85.16% | 3468 | 806 | 60.72% | 15.03% | 89.61% |
| Example 3 | | | | | | | |

As can be seen from Table 2, it may be learned from the comparative examples and the examples that, the initial Coulombic efficiency of the negative electrode plates prepared by using the negative electrode materials of the examples are improved, the capacity retention rates of the batteries prepared by using the negative electrode material of the examples are improved, the ratios of 1C discharge capacity to 0.2C discharge capacity are improved, and the volume expansion rates are decreased, which indicates that, for the negative electrode material and the negative electrode plate and the battery that include the negative electrode material in the present disclosure, a negative effect of volume expansion of the negative electrode material on a battery is reduced, so that conductivity of the negative electrode material is improved, initial Coulombic efficiency of the negative electrode plate is improved, cycling stability of the battery is improved, and a volume expansion rate of the battery is reduced.

The foregoing describes in detail preferred embodiments of the present disclosure, but the present disclosure is not limited thereto. Within the scope of the technical concepts of the present disclosure, various simple variations can be made to the technical solutions of the present disclosure, including combining various technical features in any other suitable manner. These simple variations and combinations shall also be considered as part of the content disclosed by the present disclosure and fall within the scope of protection of the present disclosure.

What is claimed is:

1. A negative electrode material, wherein the negative electrode material has a core-shell structure, a shell layer comprises a carbon layer, a core comprises porous carbon and silicon particles distributed in an outer pore of the porous carbon, the porous carbon further comprises an inner pore, and the negative electrode material comprises a metal element.

2. The negative electrode material according to claim 1, wherein the metal element comprises a first metal element and a second metal element.

3. The negative electrode material according to claim 2, wherein the first metal element comprises one or more of iron, nickel, manganese, copper, or calcium, and the second metal element comprises lithium and/or sodium.

4. The negative electrode material according to claim 3, wherein the first metal element is in a form of a compound, and the compound comprises one or more of iron oxide, nickel oxide, manganese oxide, copper oxide, or calcium oxide; and/or
the second metal element is in a form of a compound, and the compound comprises one or more of lithium naphthalene-tetrahydrofuran or sodium naphthalene-tetrahydrofuran.

5. The negative electrode material according to claim 2, wherein a concentration of the first metal element at the core is higher than a concentration of the first metal element at the shell;
and/or a concentration of the second metal element at the shell layer is higher than a concentration of the second metal element at the core.

6. The negative electrode material according to claim 5, wherein a concentration of the first metal element in the negative electrode material gradually decreases in a direction from inside to outside; and/or a concentration of the second metal element in the negative electrode material gradually increases in a direction from inside to outside.

7. The negative electrode material according to claim 2, wherein a total weight of the negative electrode material being used as a reference, a weight content c of the first metal element meets 0.001 wt %≤c≤1.5 wt %, and a weight content d of the second metal element meets 0.001 wt %≤d≤5 wt %; and/or
in the negative electrode material, a weight ratio of the first metal element to the second metal element ranges from (0.05-10):1.

8. The negative electrode material according to claim 1, wherein a specific surface area of the porous carbon ranges from 500 m²/g to 2000 m²/g; and/or
the porous carbon comprises one or more of soft carbon, hard carbon, activated carbon, artificial graphite, or natural graphite.

9. The negative electrode material according to claim 1, wherein a median particle size Dᵥ50 of the porous carbon ranges from 5 μm to 12 μm; and/or
a difference |Dᵥ90−Dᵥ10| between Dᵥ90 and Dᵥ10 of the porous carbon is greater than 1 μm and less than or equal to 12 μm.

10. The negative electrode material according to claim 1, wherein a true density a of the negative electrode material ranges from 1.5 g/cm³ to 2.2 g/cm³; and/or
a difference e=|Dᵥ90−Dᵥ10| between particle sizes Dᵥ90 and Dᵥ10 of the negative electrode material meets 1 μm<e≤12 μm; and/or
a median particle size Dᵥ50 of the negative electrode material ranges from 5 μm to 12 μm; and/or
a specific surface area of the negative electrode material ranges from 0.5 m²/g to 20 m²/g.

11. The negative electrode material according to claim 1, wherein a total weight of the negative electrode material being used as a reference, a weight content b of a silicon element ranges from 35 wt % to 75 wt %; and/or
a true density a of the negative electrode material ranges from 1.65 g/cm³ to 2.05 g/cm³; and/or
a difference e=|Dᵥ90−Dᵥ10| between particle sizes Dᵥ90 and Dᵥ10 of the negative electrode material meets 5 μm≤e≤10 μm.

12. The negative electrode material according to claim 11, wherein a total weight of the negative electrode material being used as a reference, a weight content b of the silicon element ranges from 45 wt % to 60 wt %.

13. A negative electrode plate, comprising the negative electrode material according to claim 1.

14. The negative electrode plate according to claim 13, wherein the negative electrode plate comprises a negative electrode current collector and a negative electrode active material layer coated on at least one side surface of the negative electrode current collector, and the negative electrode active material layer comprises the negative electrode material.

15. The negative electrode plate according to claim 14, wherein the negative electrode active material layer further comprises graphite, and the graphite comprises artificial graphite and/or natural graphite.

16. The negative electrode plate according to claim 15, wherein a total weight of the negative electrode active material layer being used as a reference, a weight content of the negative electrode material ranges from 0.5 wt % to 99 wt %, and a weight content of the graphite ranges from 0 wt % to 98.5 wt %.

17. The negative electrode plate according to claim 14, wherein the negative electrode active material layer comprises a conductive agent and a binder.

18. The negative electrode plate according to claim 17, wherein a total weight of the negative electrode active material layer being used as a reference, a weight content of the conductive agent ranges from 0.5 wt % to 15 wt %, and a weight content of the binder ranges from 0.5 wt % to 15 wt %; and/or
the conductive agent comprises one or more of carbon black, acetylene black, Keqin black, carbon fiber, single-walled carbon nanotube, or multi-walled carbon nanotube; and/or
the binder comprises one or more of carboxymethyl cellulose, sodium carboxymethyl cellulose, lithium carboxymethyl cellulose, hydroxypropyl cellulose, diacetyl cellulose, polyethylene, polyvinyl alcohol, polyvinyl chloride, polyvinyl fluoride, polyvinylpyrrolidone, polytetrafluoroethylene, polypropylene, styrene-butadiene rubber, or epoxy resin.

19. A battery, comprising the negative electrode material according to claim 1.

20. The battery according to claim 19, wherein the battery comprises a lithium-ion secondary battery.
